(19) United States
(12) Patent Application Publication
(10) Pub. No.: US 2014/0108044 A1
(43) Pub. Date: Apr. 17, 2014

(54) METHODS AND SYSTEMS FOR ANALYZING HEALTH RISK SCORE AND MANAGING HEALTHCARE COST

(71) Applicants: Jayaram Reddy, Allen, TX (US); Kirit Pandit, Plano, TX (US)

(72) Inventors: Jayaram Reddy, Allen, TX (US); Kirit Pandit, Plano, TX (US)

(21) Appl. No.: 13/651,133

(22) Filed: Oct. 12, 2012

(51) Int. Cl. G06Q 50/24

(52) U.S. Cl. CPC G06Q 50/24
USPC 705/3

(57) ABSTRACT

Various disclosed embodiments include methods and systems for determining a plurality of patients' risk of hospitalization and for forecasting healthcare cost. The method includes receiving a plurality of patients' clinical data from encounters over a predetermined time period and mapping disease codes in the clinical data of the plurality of patients to respective chronic diseases. The method includes determining, for the plurality of patients, health risk scores for the respective chronic diseases by applying disease models for the respective chronic diseases to the clinical data. The method includes determining, for the plurality of patients, weighted health risk scores and determining respective healthcare costs. The method includes determining an impact of the weighted health risk scores on the healthcare costs.

### TECHNICAL FIELD

The present disclosure is directed, in general, to data processing systems and methods and, more particularly, to methods and systems for analyzing health risk score and managing healthcare cost.

### BACKGROUND OF THE DISCLOSURE

In the last several decades, healthcare spending in the U.S. has grown rapidly. According to a recent study, the per-capita healthcare spending in the U.S. increased from $1,110 in 1980 to $8,402 in 2010. Consequently, restraining the growth of healthcare spending is seen as an increased priority. Various plans have been put forward to slow the growth of healthcare spending. Some plans support greater emphasis on prevention, wellness, and public health activities to reduce the overall healthcare cost. Other plans increase payments for primary care services and support a shift from “curing the sick patient” to “keeping the population healthy”, with a focus on preventive care provided by primary care physicians. Other plans propose a change from a volume-based payment to an outcome based pay-for-performance.

### SUMMARY OF THE DISCLOSURE

Various disclosed embodiments include methods and systems for determining a plurality of patients' health risk score and for forecasting healthcare cost. The method includes receiving a plurality of patients' clinical data from encounters over a predetermined time period and mapping disease codes in the clinical data of the plurality of patients to respective chronic diseases. The method includes determining, for the plurality of patients, the health risk scores for the respective chronic diseases by applying disease models for the respective chronic diseases to the clinical data. The method includes determining, for the plurality of patients, average health risk scores of the respective chronic diseases. The method includes determining, for the plurality of patients, weighted health risk scores of the respective chronic diseases, wherein the weighted health risk score is determined from the average health risk score of the chronic disease, the average cost of hospitalization due to the chronic disease and the corresponding frequency of hospital admissions based on historical admissions analysis. The method includes determining healthcare costs of the patients. The method includes determining an impact of the health risk scores on the healthcare costs. The method includes storing the health risk scores, the weighted health risk scores and other calculated parameters in a memory.

According to disclosed embodiments, a data processing system for determining a plurality of patients' health risk score and forecasting healthcare cost includes at least one processor and a memory connected to the processor. The data processing system is configured to receive a plurality of patients' clinical data from encounters over a predetermined time period. The data processing system is configured to map disease codes in the clinical data of the plurality of patients to respective chronic diseases. The data processing system is configured to determine, for the plurality of patients, the health risk scores for the respective chronic diseases by applying disease models for the respective chronic diseases to the clinical data. The data processing system is configured to determine, for the plurality of patients, average health risk scores of the respective chronic diseases. The data processing system is configured to determine, for the plurality of patients, weighted health risk scores of the respective chronic diseases, wherein the weighted risk score is determined from the average health risk score of the chronic disease, the average cost of hospitalization due to the chronic disease and the corresponding frequency of hospital admissions. The data processing system is configured to determine healthcare costs for the patients and to determine an impact of the weighted health risk scores on the healthcare costs. The data processing system is configured to store the health risk scores and the weighted health risk scores in the memory.

The foregoing has outlined rather broadly the features and technical advantages of the present disclosure so that those skilled in the art may better understand the detailed description that follows. Additional features and advantages of the disclosure will be described hereinafter that form the subject of the claims. Those skilled in the art will appreciate that they may readily use the conception and the specific embodiment disclosed as a basis for modifying or designing other structures for carrying out the same purposes of the present disclosure. Those skilled in the art will also realize that such equivalent constructions do not depart from the spirit and scope of the disclosure in its broadest form.

Before undertaking the DETAILED DESCRIPTION below, it may be advantageous to set forth definitions of certain words or phrases used throughout this patent document: the terms “include” and “comprise,” as well as derivatives thereof, mean inclusion without limitation; the term “or” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, whether such a device is implemented in hardware, firmware, software or some combination of at least two of the same. It should be noted that the functionality associated with any particular controller may be centralized or distributed, whether locally or remotely. Definitions for certain words and phrases are provided throughout this patent document, and those of ordinary skill in the art will understand that such definitions apply in many, if not most, instances to prior as well as future uses of such defined words and phrases. While some terms may include a wide variety of embodiments, the appended claims may expressly limit these terms to specific embodiments.

### BRIEF DESCRIPTION OF THE DRAWINGS

For a more complete understanding of the present disclosure, and the advantages thereof, reference is now made to the following descriptions taken in conjunction with the accompanying drawings, wherein like numbers designate like objects, and in which:

FIG. 1 illustrates a block diagram of a data processing system according to disclosed embodiments;

FIG. 2 illustrates an exemplary block diagram for calculating SOH scores according to disclosed embodiments;

FIGS. 3 and 4 illustrate charts according to disclosed embodiments;

FIG. 5 illustrates a bar graph according to disclosed embodiments;

FIG. 6 is a screenshot of a registry according to disclosed embodiments;

FIG. 7 is a flowchart of a process according to disclosed embodiments;

FIG. 8 illustrates variation of emergency room visits and inpatient admissions based on composite health risk scores;

FIG. 9 illustrates variation of average costs per patient based on risk bands; and

FIG. 10 is a flowchart of a process according to disclosed embodiments.

### DETAILED DESCRIPTION

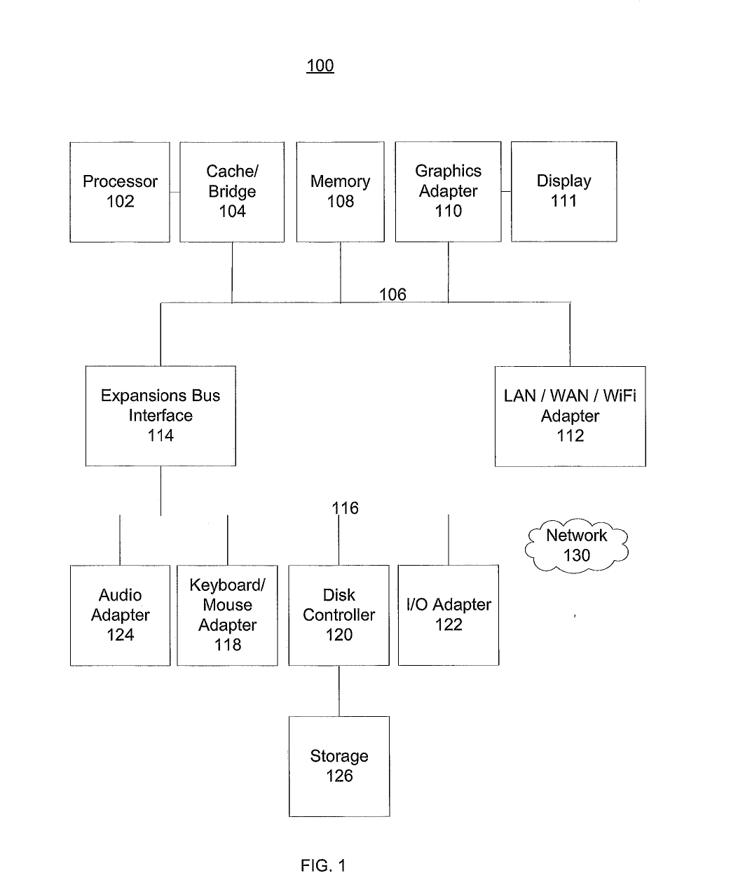

FIGS. 1 through 10, discussed below, and the various embodiments used to describe the principles of the present disclosure in this patent document are by way of illustration only and should not be construed in any way to limit the scope of the disclosure. Those skilled in the art will recognize that the principles of the present disclosure may be implemented in any suitably arranged device or a system. The numerous innovative teachings of the present disclosure will be described with reference to exemplary non-limiting embodiments.

Various disclosed embodiments provide methods and systems for determining a population's health risk score and for forecasting healthcare cost due to a chronic disease, wherein the population comprises a plurality of patients. A population's risk of hospitalization may be analyzed by a state of health (SOH) analyzer and represented by the health risk score. In this document, the health risk score is also referred to as the SOH score, and these terms are used interchangeably herein. The health risk score or SOH score may be represented by a number between 1 and 100. Alternatively, the health risk score or SOH score may be represented as a percentage (e.g., 70%, 80%).

According to disclosed embodiments, the health risk score or SOH score indicates the risk of hospitalization due to a chronic disease such as, for example, diabetes, coronary heart disease, asthma, COPD, and osteoporosis. The SOH analyzer may be used to determine the health risk score or SOH score based on information from a patient's health record such as, for example, clinical data. The clinical data may be gathered during a patent's visit to a healthcare provider. The clinical data may also be obtained while the patient is hospitalized, and such information may be obtained from, for example, an Electronic Medical Records (EMR) system.

According to disclosed embodiments, an SOH analyzer enables superior preventive care, reduce acute care admissions and reduce Per-Member Per-Month (PMPM) cost. According to disclosed embodiments, the SOH analyzer identifies patient risk using EMR data and performs risk stratification of patients by chronic conditions such as, for example, diabetes, coronary heart disease, asthma, and osteoporosis. In one aspect, the SOH analyzer predicts risk of hospitalization and also measures quality of primary care provided to chronic care patients.

According to some disclosed embodiments, the SOH analyzer stratifies results by easy to visualize color codes based on severity of risk. According to disclosed embodiments, the SOH analyzer quantifies the probability of acute care admissions due to complications and allow for early intervention to reduce hospital admissions.

According to disclosed embodiments, the SOH analyzer is a provider-centric, clinical-driven care management tool. The SOH analyzer promotes superior care management through best practices and comparative effectiveness for chronic conditions. The SOH analyzer helps in the understanding of the effectiveness of wellness and benefits programs. The SOH analyzer also benchmarks provider performance and impact on PMPM costs.

Healthcare Providers

According to disclosed embodiments, healthcare providers may use the health risk score to identify high risk patients by chronic conditions based on clinical data. Using the SOH analyzer and the health risk score, healthcare providers may classify patients into risk pools and may develop optimal care-management programs. Also, healthcare providers may measure the performance and effectiveness of various care management programs.

Self-Insured Employers

According to disclosed embodiments, the SOH analyzer and the health risk score provide self-insured employers increased visibility to the performance of the providers and care management programs. Also, self-insured employers may measure the effectiveness and return of investment (ROI) of wellness, disease management and benefit programs.

Care Coordinators

Care coordinators may utilize the SOH analyzer and the health risk score to identify successful care management and well-being programs and the return of investment (ROI). Also, care coordinators may utilize the SOH analyzer and the health risk score to identify providers that are successful in providing Quality-of-Care at optimal costs.

Provider Management

Provider management may utilize the SOH analyzer and the health risk score to assess the impact of primary care on reducing the Per-Member Per-Month (PMPM) cost. Provider management may also utilize the SOH analyzer and the health risk score to negotiate better rates with healthcare plans and payers.

FIG. 1 depicts a block diagram of data processing system 100 in which an embodiment can be implemented, for example as a system particularly configured by software or otherwise to perform the processes as described herein, and in particular as each one of a plurality of interconnected and communicating systems as described herein. Data processing system 100 may be implemented as an SOH analyzer according to disclosed embodiments. The data processing system depicted includes processor 102 connected to level two cache/bridge 104, which is connected in turn to local system bus 106. Local system bus 106 may be, for example, a peripheral component interconnect (PCI) architecture bus. Also connected to local system bus in the depicted example are main memory 108 and graphics adapter 110. Graphics adapter 110 may be connected to display 111.

Other peripherals, such as local area network (LAN)/Wide Area Network/Wireless (e.g. WiFi) adapter 112, may also be connected to local system bus 106. Expansion bus interface 114 connects local system bus 106 to input/output (I/O) bus 116. I/O bus 116 is connected to keyboard/mouse adapter 118, disk controller 120, and I/O adapter 122. Disk controller 120 can be connected to storage 126, which can be any suitable machine usable or machine readable storage medium, including but not limited to nonvolatile, hard-coded type mediums such as read only memories (ROMs) or erasable, electrically programmable read only memories (EEPROMs), magnetic tape storage, and user-recordable type mediums such as floppy disks, hard disk drives and compact disk read only memories (CD-ROMs) or digital versatile disks (DVDs), and other known optical, electrical, or magnetic storage devices.

Also connected to I/O bus 116 in the example shown is audio adapter 124, to which speakers (not shown) may be connected for playing sounds. Keyboard/mouse adapter 118 provides a connection for a pointing device (not shown), such as a mouse, trackball, trackpointer, etc.

Those of ordinary skill in the art will appreciate that the hardware depicted in FIG. 1 may vary for particular implementations. For example, other peripheral devices, such as an optical disk drive and the like, also may be used in addition or in place of the hardware depicted. The depicted example is provided for the purpose of explanation only and is not meant to imply architectural limitations with respect to the present disclosure.

Data processing system 100 in accordance with an embodiment of the present disclosure includes an operating system employing a graphical user interface. The operating system permits multiple display windows to be presented in the graphical user interface simultaneously, with each display window providing an interface to a different application or to a different instance of the same application. A cursor in the graphical user interface may be manipulated by a user through the pointing device. The position of the cursor may be changed and/or an event, such as clicking a mouse button, generated to actuate a desired response.

One of various commercial operating systems, such as a version of Microsoft Windows™, a product of Microsoft Corporation located in Redmond, Wash. may be employed if suitably modified. The operating system is modified or created in accordance with the present disclosure as described.

LAN/WAN/Wireless adapter 112 can be connected to network 130 (not a part of data processing system 100), which can be any public or private data processing system network or combination of networks, as known to those of skill in the art, including the Internet. Data processing system 100 can communicate over network 130 with server system 140, which is also not part of data processing system 100, but can be implemented, for example, as a separate data processing system 100. Data processing system 100 may be configured as a workstation, and a plurality of similar workstations may be linked via a communication network to form a distributed system in accordance with embodiments of the disclosure.

According to disclosed embodiments, a population's clinical data is obtained. The population comprises a plurality of patients. The clinical data may be obtained from electronic health records or may otherwise be obtained manually. It will be appreciated that the clinical data may be gathered from a plurality of encounters over a period of time. An encounter may be a patient visit to a healthcare provider or an encounter may be a hospitalization due to a chronic condition.

According to some disclosed embodiments, the following information may be obtained:
Patient: date of birth, gender, race
Then for each encounter (visit) by the patient:
Vitals (e.g., age, height, weight (BMI), temperature, heart rate, blood pressure)
Labs ordered
Lab results (e.g., blood sugar, HbA1c, LDL-C, HDL-C, triglycerides) Medications prescribed
Diagnosis codes (e.g., ICD codes)
Procedure codes (ICD, CPT codes)
Charges
Claims
Payments
Hospital admission dates, charges, diagnosis codes
Pharmacy (medications ordered)

According to some disclosed embodiments, the clinical data is examined by system 100, which may be implemented as an SOH analyser, to identify one of more chronic diseases the patient may have been diagnosed with. For example, ICD 9 codes entered in an encounter may indicate the chronic diseases. It will be appreciated that ICD (international classification of diseases) is a classification system for assigning specific diseases or conditions to a patient. For example ICD 9=250.xx covers various types of diabetes. Thus, ICD 9=250.3 indicates that a patient has been diagnosed with a particular type of diabetes.

According to some disclosed embodiments, ICD 9 codes for an encounter are mapped to corresponding chronic diseases. A database mapping ICD 9 codes to chronic diseases may be maintained.

According to some disclosed embodiments, if the clinical data for an encounter does not have a recorded ICD 9 code that maps to a chronic condition but a previous encounter has a recorded ICD 9 code, then the previously recorded ICD 9 code is propagated forward, unless the patient has a ‘resolved’ status for that chronic condition. A resolved status may indicate that the patient's chronic condition has been cured.

According to some disclosed embodiments, predetermined disease models are applied to the clinical data related to calculate a health risk score, which is also referred to as the SOH score. According to some disclosed embodiments, the health risk score or SOH score is calculated for the chronic diseases for each patient encounter. By way of example, an encounter may indicate that a particular patient has been diagnosed with diabetes and CHD. Accordingly, predetermined disease models for both diabetes and CHD are applied to the respective clinical data obtained during the encounter to calculate the health risk score for diabetes and CHD. According to some disclosed embodiments, the health risk score may be represented by a number between 0 and 100 or may be represented by as a percentage (%). A high health risk score related to a chronic disease may indicate relatively poor health of a patient, and thus a relatively high risk of hospitalization due to the chronic disease. A low health risk score may indicate relatively good health of a patent and thus a relatively low risk of hospitalization due to the chronic disease.

According to disclosed embodiments, the disease models are clinically validated models developed using multi-year trials on large patient populations. The disease models utilize regression equations to determine the relationship between causal factors (independent variables) and outcomes. The regression equations predict the probability of an outcome based on the clinical data. The regression equations are well known to those skilled in the art and thus will not be described herein.

According to some disclosed embodiments, the health risk score is calculated for diabetes, asthma, COPD and depression only if a patient is diagnosed with that chronic disease. For example, if a patient is diagnosed with diabetes, the health risk score is calculated according to the corresponding disease model for diabetes. For patients that are not diagnosed with diabetes, a zero is assigned as the health risk score for diabetes.

According to some disclosed embodiments, for all patients, the health risk score is calculated for pre-diabetes, hypertension, CAD, CHF and AVD.

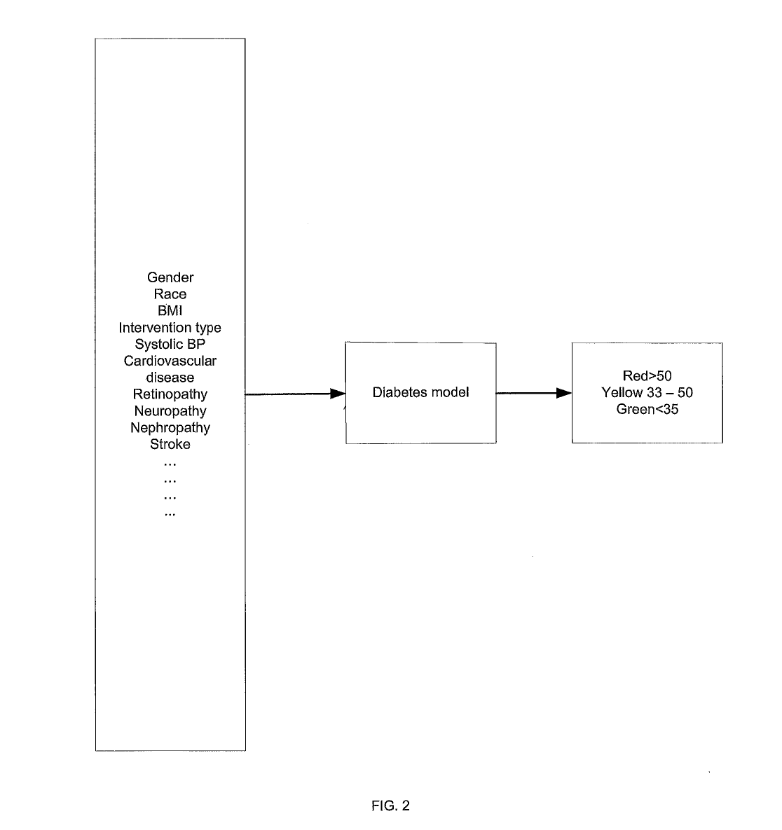

FIG. 2 illustrates an exemplary block diagram for calculation of the health risk score for diabetes according to disclosed embodiments. Clinical data 204 is applied to diabetes model 208 to generate health risk scores 212. As discussed before, diabetes model 208 may be implemented using regression equations. The resulting health risk score may be classified into one of three categories and may also be color coded. For example, a health risk score above 50 may be classified into a high risk category and may be color coded red. A health risk score between 33 and 50 may be classified into a medium risk category and may be color coded yellow. A health risk score below 35 may be classified into a low risk category and may be color coded green.

According to some disclosed embodiments, the health risk score for a patient diagnosed with diabetes may be calculated using guidelines provided in Table 1 below. Initially, for both male and female patients with type 2 diabetes, a baseline number of 0.31 is assigned. If the patient is a white female, 0.038 is added to the score. If the female patient has a BMI of 35, 0.021*5=0.105 is added to the score. If the female patent is on insulin, 0.034 is added to the score. If the female patient has regular neuropathy, 0.065 is added to the score. If the female patient is diagnosed with congestive heart failure, 0.052 is added to the score. Finally, if the female patient is diagnosed with hypertension, 0.011 is added to the score. Based on the above, the health risk score for the female patient diagnosed with diabetes is 0.615 or 61.5%.

TABLE 1

| | | |
|---|---|---|
| Baseline: | Healthy diet-controlled Diabetic 2 | 0.31 |
| | white male with no complications | |
| | or co-morbidities | |
| Sex | Male | 0 |
| | Female | 0.038 |
| BMI (kg/m2) | Obese | 0.021 |
| For every unit above 30 | | |
| (kg/m2) | | |
| Diabetic Intervention | Diet Controlled | 0 |
| | Oral Antidiabetic Agents | 0.023 |
| | Insulin | 0.034 |
| Retinopathy | Blind in one-eye | 0.043 |
| | Blind in two-eyes | 0.17 |
| Nephropathy | Microalbuminuria | 0.011 |
| | Proteinuria | 0.011 |
| | ESRD with dialysis | 0.078 |
| Neuropathy | Tingling and burning | 0.06 |
| | Neuropathy | 0.065 |
| | Sores | 0.099 |
| | History of amputation | 0.105 |
| Stroke | Transient ischemic attack or stroke | 0.044 |
| | Stroke with residual | 0.072 |
| Cardiovascular disease | Congestive heart failure | 0.052 |
| Blood Pressure | High blood pressure | 0.011 |

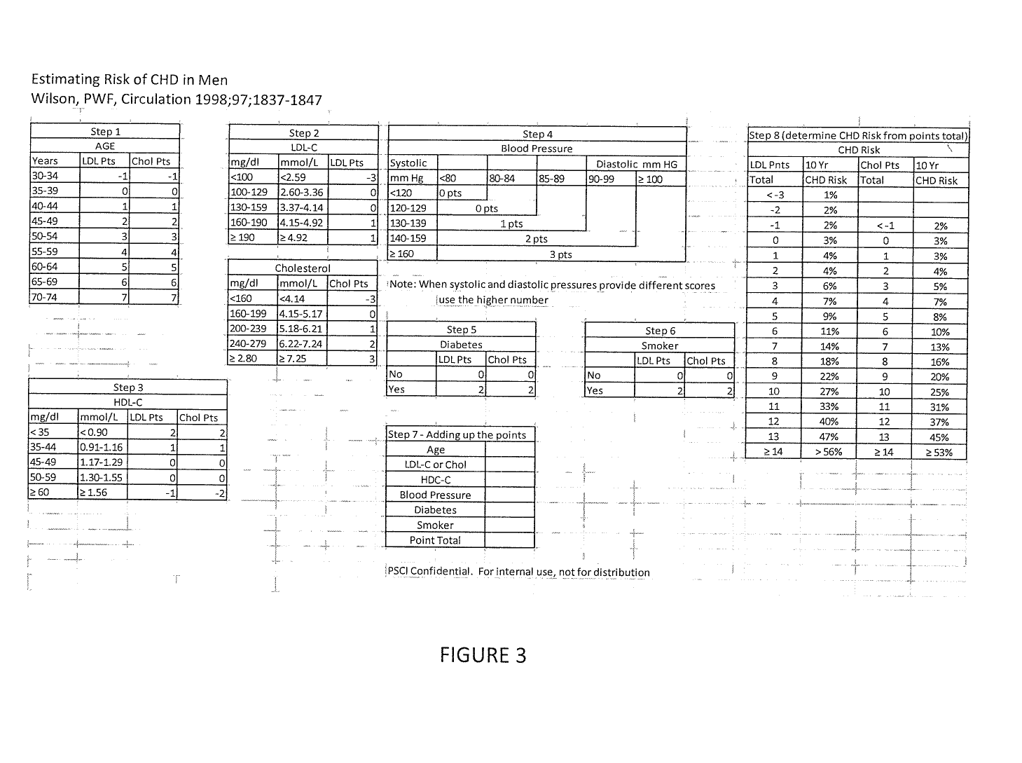

According to some disclosed embodiments, the health risk score for a patient diagnosed with coronary heart disease (CHD) may be calculated using guidelines in charts shown in FIG. 3, which shows various steps used in calculating the health risk score. Consider, for example, a 52 year old non-smoking male with the following conditions: LDL=192; HDL=46; systolic BP=130; and diastolic BP=90. Using the steps in FIG. 3, the health risk score is calculated to be 9, which corresponds to 22%.

According to some disclosed embodiments, the health risk score for a patient diagnosed with asthma may be calculated using guidelines in charts shown in FIG. 4. In FIG. 4, each parameter is listed along with points to be added to the score. For example, if total points for a patient equal 9, the health risk score is 50%.

According to some disclosed embodiments, if an encounter does not have recorded values for any vital signs, the previously recorded values for vital signs are propagated forward. Consider, for example, in an encounter (visit) on Jan. 6, 2012 a patient had a recorded LDL cholesterol value of 150. In his next encounter (visit) on Jun. 4, 2012, no LDL value was recorded. Accordingly, the LDL value of 150 is used for Jun. 4, 2012 encounter.

According to some disclosed embodiments, if a parameter value for any vital sign is not available across any encounter, reasonable approximations are used depending on the parameter. For example, if a Body Mass Index (BMI) value is not available, an ideal BMI of 22.5 is used.

According to some disclosed embodiments, the calculated health risk scores are normalized using a scale between 1 and 100. Next, an average health risk score over a predetermined time period for each patient for each chronic disease is calculated. For example, the average health risk score of a patient during a 12 month period may be calculated. If the patient's last encounter (visit) was on Jul. 6, 2012, then encounters between Jul. 7, 2011 and Jul. 6, 2011 may be considered. Consider, for example, a patient had one encounter in each quarter during a 12 month time period and the health risk scores for diabetes were as follows:

Quarter 4, 2011: 50

Quarter 1, 2012: 60

Quarter 2, 2012: 50

Quarter 3, 2012: 60

Based on the above, the average health risk score is 55.

According to some disclosed embodiments, the average health risk scores are classified into one of a plurality of risk categories. For example, the average health risk scores may be classified into high risk, moderate risk and low risk categories.

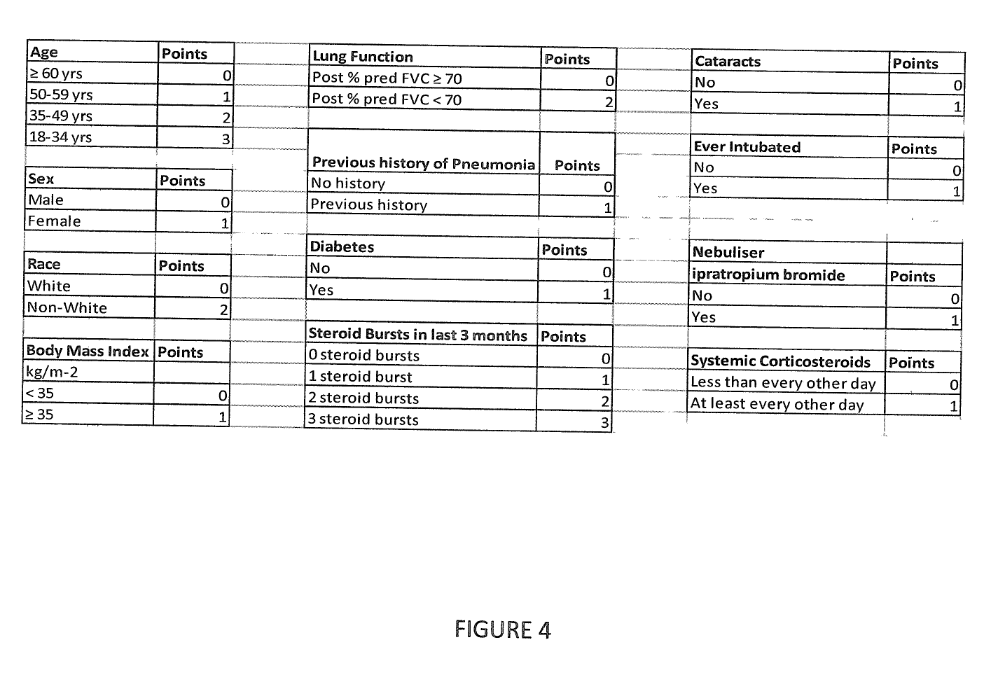

According to some disclosed embodiments, the calculated average health risk scores for each patient are illustrated against percentage of patients hospitalized. It will be appreciated that data regarding the number of times the patient was hospitalized (i.e., frequency of hospitalization) may be obtained from the claims data from payer 9. FIG. 5 illustrates a bar graph of health risk scores versus percentage hospitalized. According to some embodiments, the hospitalization percentage includes emergency room visits and acute care. Referring to FIG. 5, the x axis represents the health risk scores and the y axis represents the percentage hospitalized. By way of example, only 10% of the patients with health risk scores were between 20 and 30 were hospitalized, 30% of the patients with health risk scores greater than 50 were hospitalized, while 70% of the patients with health risk scores greater than 70 were hospitalized. FIG. 5, thus, indicates that as the health risk score increases, the risk of hospitalization also increases.

According to some disclosed embodiments, using the bar graph of FIG. 5, high, medium and low risk patients may be identified. For example, if a 70% probability of hospitalization is considered to be a high risk, then a health risk score of 70 or more may be classified as a high risk. If a 30% probability of hospitalization is considered to be a moderate risk, then the health risk score between 50 and 70 may be classified as a moderate risk. A health risk score less than 50 may be classified as a low risk.

According to some embodiments, a weighted composite health risk score for a chronic disease may be calculated using the average annual cost to treat a patient diagnosed with the chronic disease as a weight score. For example, if the average annual cost of treatment of a diabetes patient is twice that of an osteoporosis patient, the weight score for diabetes is twice the weight score for osteoporosis. Thus, the weighted composite health risk score indicates which patients are likely to be more costly. Table 2 below shows an example of the cost burdens (weights) that can be used for the chronic conditions listed in Table 2.

| | Average Hospital Bill | |
|---|---|---|
| Chronic Condition | per Admission (US$) | Relative Cost Burden |
| CAD | 51,755 | 3.3 |
| CHF | 34,270 | 2.2 |
| Diabetes | 27,930 | 1.8 |
| Asthma | 15,660 | 1.0 |

According to some disclosed embodiments, a registry of patients with similar health risk scores and characteristics may be created. The registry is a database of patients with similar characteristics and is created on the basis of chronic diseases.

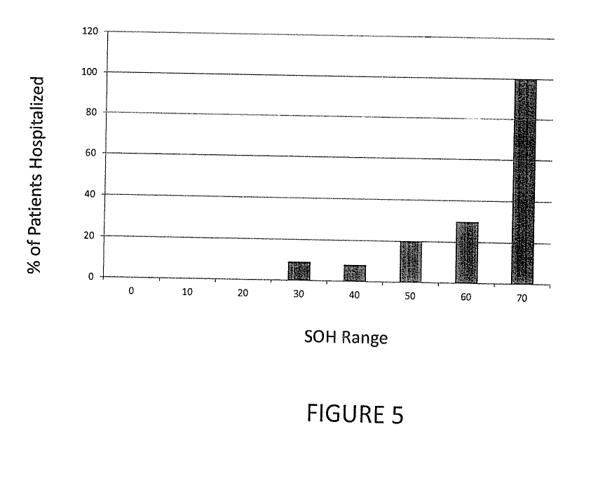

FIG. 6 is a screenshot of an exemplary registry of: (1) high risk diabetic patients; (2) high risk diabetic patients with depression; and (3) moderate risk diabetic patients with high risk of CAD.

According to some disclosed embodiments, sub-registries may be created based on additional parameters. For example, the high risk diabetic patients may be divided into the following sub-registries: (1) high risk diabetic patients with BMI>40; (2) high risk diabetic patients with HbA1C>9; and (3) high risk diabetic patients with BMI>40 and HbA1c>9 and Patient Age<40.

According to some disclosed embodiments, color codes may be assigned to patients and populations based on inclusion in sub-registries. By way of example, the patients may be color-coded as follows:

(1) High risk diabetic patients with BMI>40: color code=RED

(2) High risk diabetic patients with HbA1C>9: Color code=RED

(3) High risk diabetic patients with BMI>35 and HbA1c between 8-9; color code=YELLOW

According to some disclosed embodiments, the average health risk score in a registry may be calculated. The average health risk score in a registry may be referred to as the population health risk score for the registry. Referring to FIG. 6, the average health risk score for the chronic disease for the population in the registry is indicated.

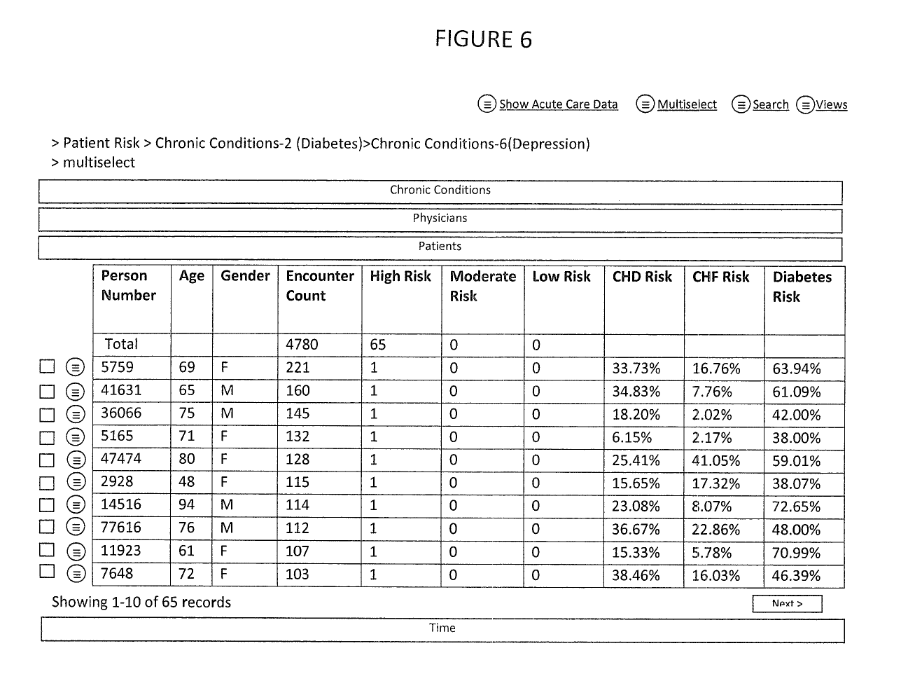

FIG. 7 is a flowchart of a process according to disclosed embodiments.

Such a process can be performed, for example, by system 100, which may be implemented as an SOH analyzer, as described above, but the “system” in the process below can be any apparatus configured to perform a process as described.

In block 704, system 100 receives a patient's clinical data. As discussed before, the clinical data may be collected from a plurality of encounters over a predetermined time period.

In block 708, system 100 maps disease codes in the clinical data to respective chronic diseases. In block 712, system 100 determines health risk scores for the respective chronic diseases. As discussed before, the health risk score is calculated by applying disease models for the respective chronic diseases to the clinical information.

In block 716, system 100 determines average health risk scores of the respective chronic diseases from the plurality of encounters over the predetermined time period. In block 720, system determines weighted health risk scores of the respective chronic diseases. The weighted health risk score is determined from the average health risk score of the chronic disease and the average cost of hospitalization due to the chronic disease. In block 724, system 100 stores the results in a memory.

A population's health risk score impacts healthcare cost and return on investment (ROI) of care management programs. According to disclosed embodiments, the health risk score's impact on healthcare cost a return on investment (ROI) of a care management program are measured.

According to disclosed embodiments, payments made by the health insurance companies and self-insured employers across a continuum-of-care are measured in terms of Per-Member Per-Month (PMPM) costs. Since a healthy member of a health plan has a lower PMPM cost compared to a member with chronic conditions, it is an objective of healthcare providers (e.g., primary care providers) to keep their populations healthy to minimize the PMPM costs for the payers under pay-for-performance plans negotiated between payers and providers.

Impact of Health Risk Score on Healthcare Cost

According to some disclosed embodiments, historical composite health risk scores for a population are computed. According to disclosed embodiments, health risk scores for a target population by employer, plan, Accountable Care Organization, etc., are calculated for chronic conditions at encounter-level, patient-level, and population-level. The health risk scores may be calculated for the previous 1, 5, or 10 years depending on the historical data availability.

Consider, for example, a patient had three encounters (visits) during the last 12 months. In each encounter, the vitals and clinical lab results were recorded in the EMR. For each encounter, the health risk score is calculated for the following chronic conditions: CHF, diabetes, COPD, Asthma. Assume that the health risk scores due to CHF in the three encounters were 12, 16, and 14, respectively. Thus, the average health risk score due to CHF for the last 12-month period is 14.

According to disclosed embodiments, the foregoing calculations are repeated to calculate the health risk scores for all chronic conditions for the patient. Next, the health risk scores for each chronic condition for the members of the population are calculated using the foregoing methods. Next, the average health risk score for each condition for the population is calculated. According to some disclosed embodiments, the average health risk score during the most recent 12-month period for each chronic condition may be determined.

According to disclosed embodiments, based on the health risk scores for the population for each chronic condition, the composite health risk scores for the chronic conditions are determined using the methods described before.

According to disclosed embodiments, historical claims data are collected across a continuum-of-care for a predetermined time period to identify major drivers of quality of care and cost. For example, historical claims data for the following may be collected: (1) number of inpatient admissions; (2) number of re-admissions; (3) number of emergency room visits; (4) utilization of patient care resources such as, for example pharmacies, labs.

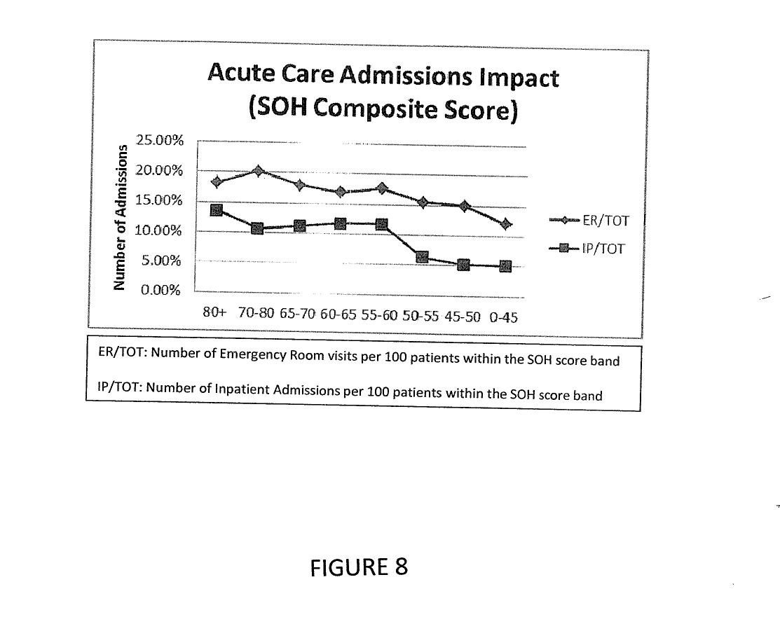

According to disclosed embodiments, the quality of care drivers per patient are mapped to the population composite health risk scores. FIG. 8 illustrates Emergency Room (ER) visits and Inpatient (IP) admissions per 100 patients for the following composite health risk score bands: 80+; 70-80; 65-70.

According to disclosed embodiments, a relationship between the composite health risk scores and the drivers of quality of care and cost are calculated. For example, the drivers of quality of care and cost may include ER visits, IP admissions and readmissions, length of stay in the hospital, resource utilization costs (e.g., pharmacy, imaging, lab tests). As illustrated in FIG. 8, 20 ER visits occurred for groups of 100 patients with composite health risk score above 70, but only 15 ER visits occurred for groups of 100 patients with composite health risk score between 50 and 55.

According to some disclosed embodiments, based on the relationship of drivers of quality of care and cost to health risk scores, a plurality of risk bands may be defined. For example, a health risk score above 70 may be classified into a high risk category, a score between 55 and 70 may be classified into a medium risk category, and a score below 55 may be classified into a low risk category.

According to disclosed embodiments, a relationship between composite health risk score and healthcare cost may be established. According to some disclosed embodiments, the healthcare cost may be defined as the PMPM cost, although other known metrics may be used to define the healthcare cost. PMPM cost may be calculated by summing all costs related to a patient over a predetermined time period (e.g., 12 months). The costs may include ambulatory, acute care admissions, pharmacy, lab tests, post-acute care costs, rehab, home care, etc.

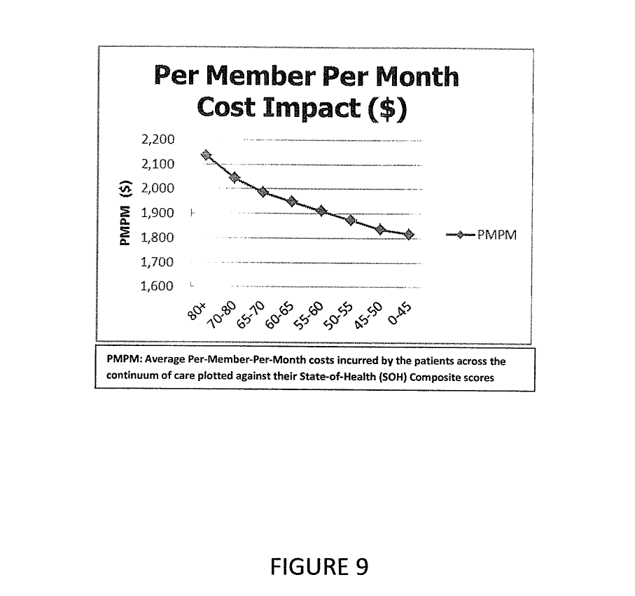

FIG. 9 illustrates a relationship between average costs incurred per patient over a 12-month period and a plurality of risk bands (e.g., 80+, 70-80, 65-70). It will be appreciated that a relationship between composite health risk score and PMPM cost may be recorded in a lookup table.

As illustrated in FIG. 9, on average a patient with a composite health risk score above 80 spends $2,100 per-month, while a patient with a composite health risk score between 55 and 60 spends $1,900 per-month.

According to some disclosed embodiments, the difference between the PMPM costs for a composite health risk score of X1 and a composite health risk score of X2 may be determined from lookup table, and the difference may be represented as a percentage impact on PMPM cost. The cost impact at a population level may be calculated by multiplying the PMPM impact per patient with the number of patients in the population. Thus, the disclosed embodiments indicate how the PMPM cost may be varied by changing the composite health risk score. By way of example, the PMPM cost may be varied by managing the quality of care drivers through care management, diagnosis and treatment. The ROI impact may be defined as the change in the PMPM cost between a first and a second composite health risk score (e.g., X1 and X2) divided by the PMPM cost.

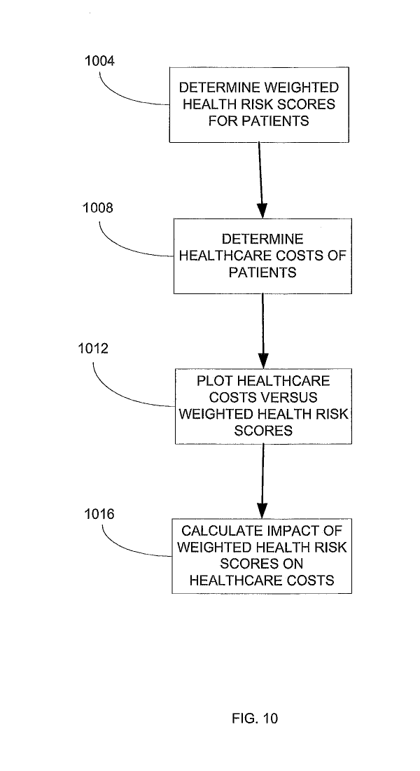

FIG. 10 is a flowchart of a process according to disclosed embodiments. Such a process can be performed, for example, by system 100, which may be implemented as an SOH analyzer, as described above, but the “system” in the process below can be any apparatus configured to perform a process as described. In block 1004, weighted health risk scores for a plurality of patients are determined using the foregoing methods. In block 1008, health care cost for the patients are calculated. According to disclosed embodiments, the healthcare cost may be represented by the PMPM cost, although other known metrics may be used to represent the healthcare cost. In block 1012, the healthcare cost may be plotted against the composite health risk scores. In block 1016, the impact of the weighted health risk scores on the healthcare costs (e.g., PMPM costs) is determined by the foregoing methods.

According to some disclosed embodiments, a non-transitory computer-readable medium encoded with computer-executable instructions determines a plurality of patients' health risk score and forecasts healthcare cost. The computer-executable instructions when executed cause at least one data processing system to: receive a plurality of patient's clinical data from encounters over a predetermined time period; map disease codes in the clinical data of the plurality of patients to respective chronic diseases; determine, for the plurality of patients, health risk scores for the respective chronic diseases by applying disease models for the respective chronic diseases to the clinical information; determine, for the plurality of patients, average health risk scores of the respective chronic diseases; and determine, for the plurality of patients, weighted health risk scores of the respective chronic diseases, wherein the weighted health risk score is determined from the average health risk score of the chronic disease, the average cost of hospitalization due to the chronic disease, and the frequency of hospitalization; determine healthcare costs for the plurality of patients; and determine an impact of the weighted health risk scores on the healthcare costs.

Those skilled in the art will recognize that, for simplicity and clarity, the full structure and operation of all systems suitable for use with the present disclosure is not being depicted or described herein. Instead, only so much of a system as is unique to the present disclosure or necessary for an understanding of the present disclosure is depicted and described. The remainder of the construction and operation of the disclosed systems may conform to any of the various current implementations and practices known in the art.

Of course, those of skill in the art will recognize that, unless specifically indicated or required by the sequence of operations, certain steps in the processes described above may be omitted, performed concurrently or sequentially, or performed in a different order. Further, no component, element, or process should be considered essential to any specific claimed embodiment, and each of the components, elements, or processes can be combined in still other embodiments.

It is important to note that while the disclosure includes a description in the context of a fully functional system, those skilled in the art will appreciate that at least portions of the mechanism of the present disclosure are capable of being distributed in the form of instructions contained within a machine-usable, computer-usable, or computer-readable medium in any of a variety of forms, and that the present disclosure applies equally regardless of the particular type of instruction or signal bearing medium or storage medium utilized to actually carry out the distribution. Examples of machine usable/readable or computer usable/readable mediums include: nonvolatile, hard-coded type mediums such as read only memories (ROMs) or erasable, electrically programmable read only memories (EEPROMs), and user-recordable type mediums such as floppy disks, hard disk drives and compact disk read only memories (CD-ROMs) or digital versatile disks (DVDs).

Although an exemplary embodiment of the present disclosure has been described in detail, those skilled in the art will understand that various changes, substitutions, variations, and improvements disclosed herein may be made without departing from the spirit and scope of the disclosure in its broadest form.

None of the description in the present application should be read as implying that any particular element, step, or function is an essential element which must be included in the claim scope: the scope of patented subject matter is defined only by the allowed claims. Moreover, none of these claims are intended to invoke paragraph six of 35 USC §112 unless the exact words “means for” are followed by a participle.

What is claimed is:

1. A method of determining a plurality of patients' health risk scores and managing healthcare cost, comprising:
receiving a plurality of patient's clinical data from encounters over a predetermined time period;
mapping disease codes in the clinical data to respective chronic diseases;
determining, for the plurality of patients, health risk scores for the respective chronic diseases by applying disease models for the respective chronic diseases to the clinical data;
determining, for the plurality of patients, average health risk scores of the respective chronic diseases; and
determining, for the plurality of patients, weighted health risk scores of the respective chronic diseases, wherein the weighted health risk score is determined from the average health risk score of the chronic disease and the average cost of hospitalization due to the chronic disease;
determining healthcare costs for the patients;
determining an impact of the weighted health risk scores on the healthcare costs;
storing weighted health risk scores in a memory.

2. The method of claim 1, further comprising classifying the patients into a plurality of risk categories based on the respective health risk scores and number of hospitalizations.

3. The method of claim 1, further comprising generating, for the plurality of patients, plots illustrating health risk scores versus number of hospitalizations.

4. The method of claim 1, wherein the disease code is based on International Classification of Diseases.

5. The method of claim 1, wherein the clinical data comprises patient vitals, number of hospitalizations, laboratory results, prescribed medications and charges.

6. The method of claim 1, wherein the encounter occurs when a patient visits a healthcare provider.

7. The method of claim 1, wherein the health risk score indicates the risk of hospitalization due to the chronic disease.

8. The method of claim 1, wherein the weighted health risk score is a forecast of the future healthcare cost.

9. A data processing system for determining a plurality of patients' health risk scores and managing healthcare cost, comprising:
at least one processor;
a memory connected to the processor, wherein the data processing system is configured to:
receive a plurality of patient's clinical data from encounters over a predetermined time period;
map disease codes in the clinical data to respective chronic diseases;
determine, for the plurality of patients, health risk scores for the respective chronic diseases by applying disease models for the respective chronic diseases to the clinical data;
determine, for the plurality of patients, average health risk scores of the respective chronic diseases; and
determine, for the plurality of patients, weighted health risk scores of the respective chronic diseases, wherein the weighted health risk score is determined from the average health risk score of the chronic disease and the average cost of hospitalization due to the chronic disease;
determine healthcare costs for the patients;
determine an impact of the weighted health risk scores on the healthcare costs; and
store the weighted health risk scores in the memory.

10. The data processing system of claim 9, wherein the disease code is based on International Classification of Diseases.

11. The data processing system of claim 9, wherein the clinical data comprises patient vitals, number of hospitalizations, laboratory results, prescribed medications and charges.

12. The data processing system of claim 9, wherein the encounter occurs when a patient visits a healthcare provider.

13. The data processing system of claim 9, wherein the risk score indicates the risk of hospitalization due to the chronic disease.

14. The data processing system of claim 9, wherein the weighted average risk score is a forecast of the future healthcare cost.
